(19) United States
(12) Patent Application Publication
(10) Pub. No.: US 2007/0016700 A1
(43) Pub. Date: Jan. 18, 2007

(54) Integrated circuit device and electronic instrument

(75) Inventors: Satoru Kodaira, Chino-shi (JP); Noboru Itomi, Nirasaki-shi (JP); Takashi Kumagai, Chino-shi (JP); Satoru Ito, Suwa-shi (JP); Junichi Karasawa, Tatsuno-machi (JP); Shuji Kawaguchi, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/477,669

(22) Filed: Jun. 30, 2006

(30) Foreign Application Priority Data
Jun. 30, 2005 (JP) 2005-192681
Feb. 10, 2006 (JP) 2006-034516

(51) Int. Cl. G06F 5/00; G06F 3/00

(52) U.S. Cl. 710/52

(57) ABSTRACT

An integrated circuit device has a data memory including a memory cell array which includes a plurality of wordlines, a plurality of bitlines, and a plurality of memory cells, and a memory output circuit. The data read order in the memory cell array corresponding to the arrangement of the bitlines differs from the data output order from the memory output circuit. The integrated circuit device includes a rearrangement interconnect region in a region of the memory output circuit. The rearrangement interconnect region rearranges data input in the data read order using interconnects and outputs the data in the data output order.

Japanese Patent Application No. 2005-192681 filed on Jun. 30, 2005 and Japanese Patent Application No. 2006-34516 filed on Feb. 10, 2006, are hereby incorporated by reference in their entirety.

### BACKGROUND OF THE INVENTION

The present invention relates to an integrated circuit device and an electronic instrument.

In recent years, an increase in resolution of a display panel provided in an electronic instrument has been demanded accompanying a widespread use of electronic instruments. Therefore, a driver circuit which drives a display panel is required to exhibit high performance. However, since many types of circuits are necessary for a high-performance driver circuit, the circuit scale and the circuit complexity tend to be increased in proportion to an increase in resolution of a display panel. Therefore, since it is difficult to reduce the chip area of the driver circuit while maintaining the high performance or providing another function, manufacturing cost cannot be reduced.

A high-resolution display panel is also provided in a small electronic instrument, and high performance is demanded for its driver circuit. However, the circuit scale cannot be increased to a large extent since a small electronic instrument is limited in space. Therefore, since it is difficult to reduce the chip area while providing high performance, a reduction in manufacturing cost or provision of another function is difficult.

JP-A-2001-222276 discloses a RAM integrated liquid crystal display driver, but does not teach a reduction in size of the liquid crystal display driver.

### SUMMARY

According to a first aspect of the invention, there is provided an integrated circuit device having a data memory which includes a memory cell array including a plurality of wordlines, a plurality of bitlines, and a plurality of memory cells, and a memory output circuit,

wherein data read order in the memory cell array corresponding to arrangement of the bitlines differs from data output order from the memory output circuit;

wherein the integrated circuit device includes a rearrangement interconnect region in a region of the memory output circuit; and

wherein the rearrangement interconnect region rearranges data input in the data read order using interconnects and outputs the data in the data output order.

### BRIEF DESCRIPTION OF THE SEVERAL VIEWS OF THE DRAWING

FIGS. 1A and 1B are diagrams showing an integrated circuit device according to one embodiment of the invention.

FIG. 2A is a diagram showing a part of a comparative example for the embodiment, and FIG. 2B is a diagram showing a part of the integrated circuit device according to the embodiment.

FIGS. 3A and 3B are diagrams showing a configuration example of the integrated circuit device according to the embodiment.

FIG. 4 is a configuration example of a display memory according to the embodiment.

FIG. 5 is a cross-sectional diagram of the integrated circuit device according to the embodiment.

FIGS. 6A and 6B are diagrams showing a configuration example of a data line driver.

FIG. 7 is a configuration example of a data line driver cell according to the embodiment.

FIG. 8 is a diagram showing a comparative example according to the embodiment.

FIGS. 9A to 9D are diagrams illustrative of the effect of a RAM block according to the embodiment.

FIG. 10 is a diagram showing the relationship of the RAM blocks according to the embodiment.

FIGS. 11A and 11B are diagrams illustrative of reading of data from the RAM block.

FIG. 12 is a diagram illustrative of a RAM block used in the embodiment for reading data twice in one horizontal scan period, which is divided into four blocks and rotated at 90 degrees.

FIG. 13 is a diagram showing block division of a RAM and a source driver.

FIG. 14 is a schematic diagram illustrative of a RAM integrated data driver block formed by dividing the RAM block into eleven blocks as shown in FIG. 13.

FIG. 15 is a diagram illustrative of a state in which the data read order in a memory cell array corresponding to the arrangement of bitlines differs from the data output order from a memory output circuit.

FIG. 16 is a diagram showing the memory output circuit of the RAM integrated data driver block.

FIG. 17 is a circuit diagram of a sense amplifier and a buffer shown in FIG. 15.

FIG. 18 is a diagram showing the details of a rearrangement interconnect region shown in FIG. 14.

FIGS. 19A and 19B are diagrams showing electronic instruments including the integrated circuit device according to the embodiment.

FIG. 20 is a diagram showing a memory output circuit differing from the memory output circuit shown in FIG. 16.

FIG. 21 is a diagram showing a memory output circuit differing from the memory output circuits shown in FIGS. 16 and 20.

FIG. 22 is a diagram illustrative of a first switch shown in FIG. 21.

### DETAILED DESCRIPTION OF THE EMBODIMENT

The invention may provide an integrated circuit device which allows a flexible circuit arrangement to enable an efficient layout without processing the outputs from bitlines in the output order, and an electronic instrument including the same.

The invention may also provide an integrated circuit device which can increase the degrees of freedom of the sense amplifier circuit layout by reducing the effects of limitations to the size of memory cells, and an electronic instrument including the same.

According to one embodiment of the invention, there is provided an integrated circuit device having a data memory which includes a memory cell array including a plurality of wordlines, a plurality of bitlines, and a plurality of memory cells, and a memory output circuit,

wherein data read order in the memory cell array corresponding to arrangement of the bitlines differs from data output order from the memory output circuit;

wherein the integrated circuit device includes a rearrangement interconnect region in a region of the memory output circuit; and

wherein the rearrangement interconnect region rearranges data input in the data read order using interconnects and outputs the data in the data output order.

According to this integrated circuit device, even if the data read order corresponding to the arrangement of the bitlines differs from the data output order from the memory output circuit, the data transmission order can be rearranged in the path between the input and the output of the memory output circuit using the rearrangement interconnect region provided in the region of the memory output circuit. Therefore, the outputs from the bitlines need not be processed in the output order. Since the data is rearranged utilizing the region of the memory output circuit, the size of the integrated circuit device is not increased.

In this integrated circuit device,

the rearrangement interconnect region may include:

a first interconnect layer having a plurality of first interconnects extending along a first direction in which the bitlines extend;

a second interconnect layer having a plurality of second interconnects extending along a second direction in which the wordlines extend; and

a plurality of vias selectively connecting the first interconnects with the second interconnects between the first and second interconnect layers. A desired data rearrangement can be realized by perpendicularly changing the data transmission path using the interconnect layers.

In this integrated circuit device,

the memory output circuit may include:

a sense amplifier which detects one-bit data output from the bitlines; and

a buffer which amplifies an output from the sense amplifier; and

the rearrangement interconnect region may be disposed in a formation region of the buffer. The data can be rearranged by utilizing the interconnect layers in the region of the buffer which is the final stage of the memory output circuit.

In this integrated circuit device,

the sense amplifier may be located on an end in the first direction and include L sense amplifier cells in the first direction adjacent to L memory cells adjacent in the second direction (L is an integer larger than 1); and

data read from the L memory cells may be respectively input to the L sense amplifier cells.

When the memory cell has a small length in the wordline direction, it may be difficult to dispose one sense amplifier for one memory cell. In this case, the sense amplifier circuit arrangement is ensured by arranging L sense amplifiers in the bitline direction using the region having the length of L memory cells arranged in the wordline direction. In this case, the buffer may include L buffer cells which respectively amplify outputs from the L sense amplifier cells.

The L sense amplifier cells may be adjacently disposed in the bitline direction. The L buffer cells may be disposed adjacent to the L sense amplifier cells in a subsequent stage of the L sense amplifier cells. Note that the sense amplifier cells and the buffer cells may be alternately disposed. In either case, the rearrangement interconnect region may be disposed in a region including a final-stage buffer cell of the L buffer cells.

This integrated circuit device may comprise a data read/write circuit which receives data from and outputs data to a host device (e.g. CPU) which controls reading and writing of data from and into the memory cells. In this case, the data read order from the bitlines is set corresponding to the circuit arrangement in the data read/write circuit. In particular, when a specific number of memory cells adjacent in the wordline direction is referred to as one memory cell group, the data read/write circuit may include read sense amplifiers provided for each of the memory cell groups and data write cells provided for each of the memory cell groups. A space can be created in the wordline direction by disposing the read sense amplifier and the data write cell within the size of one memory cell group, whereby the degrees of freedom of the circuit layout of the data read/write circuit are increased. In this case, the data read order from the memory cells is determined corresponding to data stored in each of the memory cell groups.

This integrated circuit device may comprise:

a data line driver circuit which drives the data lines based on outputs from the memory output circuit;

wherein the data output order may be set corresponding to circuit arrangement in the data line driver circuit.

For example, the data line driver circuit may include a digital-analogue converter, the digital-analogue converter may have a one-pixel conversion region in which data of each of the pixels is converted, and well structures of two one-pixel conversion regions adjacent in the wordline direction may be disposed in a mirror image across a boundary between the two one-pixel conversion regions. In this case, since grayscale data of two adjacent pixels is arranged in a mirror image, it is necessary to rearrange the data output order from the memory output circuit in the rearrangement interconnect region.

In this integrated circuit device, each of the memory cells may be formed in a shape of a rectangle having a long side along the first direction (bitline direction) and a short side along the second direction (wordline direction). Since the memory size in the wordline direction is reduced, the IC size in the wordline direction can be reduced.

In this integrated circuit device, the display memory may be divided into a plurality of RAM blocks. In this case, each of the RAM blocks includes the memory output circuit. Or, the data memory may be one of the blocks obtained by dividing a display memory which stores data of at least one frame displayed in a display panel having a plurality of pixels connected with a plurality of scan lines and a plurality of data lines. In this case, N different wordlines (N is an integer larger than 1) among the wordlines may be sequentially selected in one horizontal scan period of the display panel. This reduces the size of the display memory in the wordline direction.

According to another embodiment of the invention, there is provided an electronic instrument comprising the above integrated circuit device. Since the integrated circuit device according to the invention can be reduced in size, the integrated circuit device is particularly suitable for portable instruments.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention. In the drawings, components denoted by the same reference numbers have the same meanings.

1. Display Driver

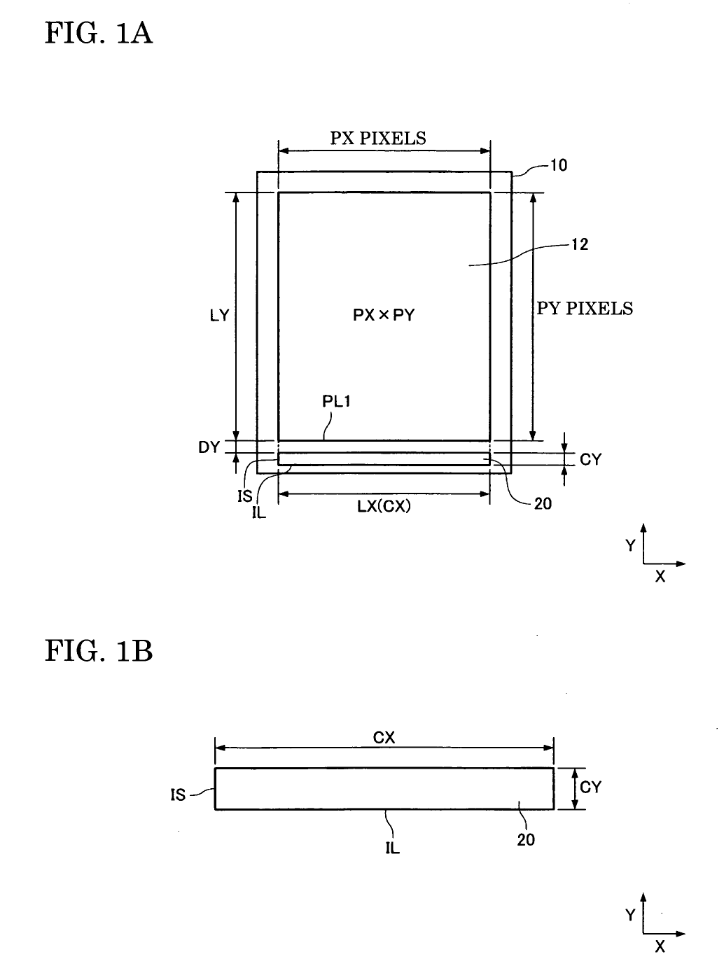

FIG. 1A shows a display panel 10 on which a display driver 20 (integrated circuit device in a broad sense) is mounted. In the embodiment, the display driver 20 or the display panel 10 on which the display driver 20 is mounted may be provided in a small electronic instrument (not shown). As examples of the small electronic instrument, a portable telephone, a PDA, a digital music player including a display panel, and the like can be given. In the display panel 10, a plurality of display pixels are formed on a glass substrate, for example. A plurality of data lines (not shown) extending in a direction Y and a plurality of scan lines (not shown) extending in a direction X are formed in the display panel 10 corresponding to the display pixels. The display pixel formed in the display panel 10 of the embodiment is a liquid crystal element. However, the display pixel is not limited to the liquid crystal element. The display pixel may be a light-emitting element such as an electroluminescence (EL) element. The display pixel may be either an active type including a transistor or the like or a passive type which does not include a transistor or the like. When the active type display pixel is applied to a display region 12, the liquid crystal pixel may be an amorphous TFT or a low-temperature polysilicon TFT.

The display panel 10 includes the display region 12 having PX pixels in the direction X and PY pixels in the direction Y, for example. When the display panel 10 supports a QVGA display, PX=240 and PY=320 so that the display region 12 is displayed in 240×320 pixels. The number of pixels PX of the display panel 10 in the direction X coincides with the number of data lines in the case of a black and white display. In the case of a color display, one pixel is formed by three subpixels including an R subpixel, a G subpixel, and a B subpixel. Therefore, the number of data lines is (3×PX) in the case of a color display. Accordingly, the “number of pixels corresponding to the data lines” means the “number of subpixels in the direction X” in the case of a color display. The number of bits of each subpixel is determined corresponding to the grayscale. When the grayscale values of three subpixels are respectively G bits, the grayscale value of one pixel is 3G. When each subpixel represents 64 grayscales (six bits), the amount of data for one pixel is 6×3=18 bits.

The relationship between the number of pixels PX and the number of pixels PY may be PX>PY, PX<PY, or PX=PY

The display driver 20 has a dimension CX in the direction X and a dimension CY in the direction Y. A long side IL of the display driver 20 having the dimension CX is parallel to a side PL1 of the display region 12 on the side of the display driver 20. Specifically, the display driver 20 is mounted on the display panel 10 so that the long side IL is parallel to the side PL1 of the display region 12.

FIG. 1B is a diagram showing the size of the display driver 20. The ratio of a short side IS of the display driver 20 having the dimension CY to the long side IL of the display driver 20 is set at 1:10, for example. Specifically, the short side IS of the display driver 20 is set to be much shorter than the long side IL. The chip size of the display driver 20 in the direction Y can be minimized by forming such a narrow display driver 20.

The above-mentioned ratio “1:10” is merely an example. The ratio is not limited thereto. For example, the ratio may be 1:11 or 1:9.

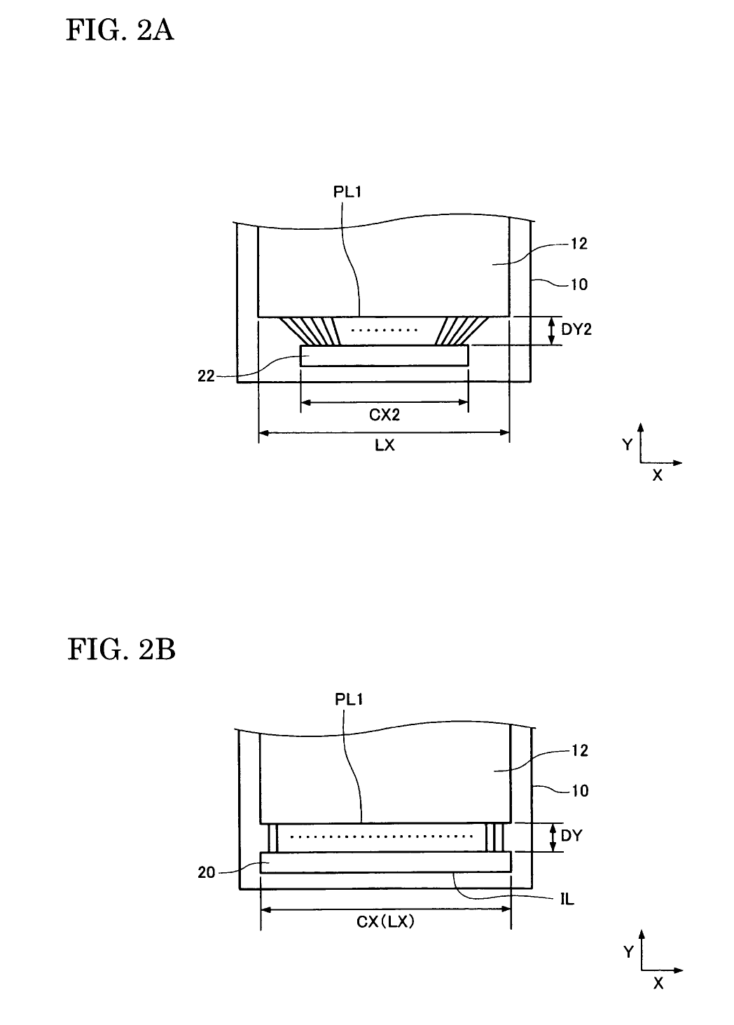

In FIG. 1A, the dimension LX of the display region 12 in the direction X is equal to the dimension CX of the display driver 20 in the direction X. It is preferable that the dimension LX and the dimension CX be equal as shown in FIG. 1A, although not limited to FIG. 1A. The reason is shown in FIG. 2A.

In a display driver 22 shown in FIG. 2A, the dimension in the direction X is set at CX2. Since the dimension CX2 is shorter than the dimension LX of the side PL1 of the display region 12, a plurality of interconnects which connect the display driver 22 with the display region 12 cannot be provided parallel to the direction Y, as shown in FIG. 2A. Therefore, it is necessary to increase a distance DY2 between the display region 12 and the display driver 22. As a result, since the size of the glass substrate of the display panel 10 must be increased, a reduction in cost is hindered. Moreover, when providing the display panel 10 in a smaller electronic instrument, the area other than the display region 12 is increased, whereby a reduction in size of the electronic instrument is hindered.

On the other hand, since the display driver 20 of the embodiment is formed so that the dimension CX of the long side IL is equal to the dimension LX of the side PL1 of the display region 12 as shown in FIG. 2B, the interconnects between the display driver 20 and the display region 12 can be provided parallel to the direction Y This enables a distance DY between the display driver 20 and the display region 12 to be reduced in comparison with FIG. 2A. Moreover, since the dimension IS of the display driver 20 in the direction Y is short, the size of the glass substrate of the display panel 10 in the direction Y is reduced, whereby the size of an electronic instrument can be reduced.

In the embodiment, the display driver 20 is formed so that the dimension CX of the long side IL is equal to the dimension LX of the side PL1 of the display region 12. However, the invention is not limited thereto.

The distance DY can be reduced while achieving a reduction in the chip size by setting the dimension of the long side IL of the display driver 20 to be equal to the dimension LX of the side PL1 of the display region 12 and reducing the dimension of the short side IS. Therefore, manufacturing cost of the display driver 20 and manufacturing cost of the display panel 10 can be reduced.

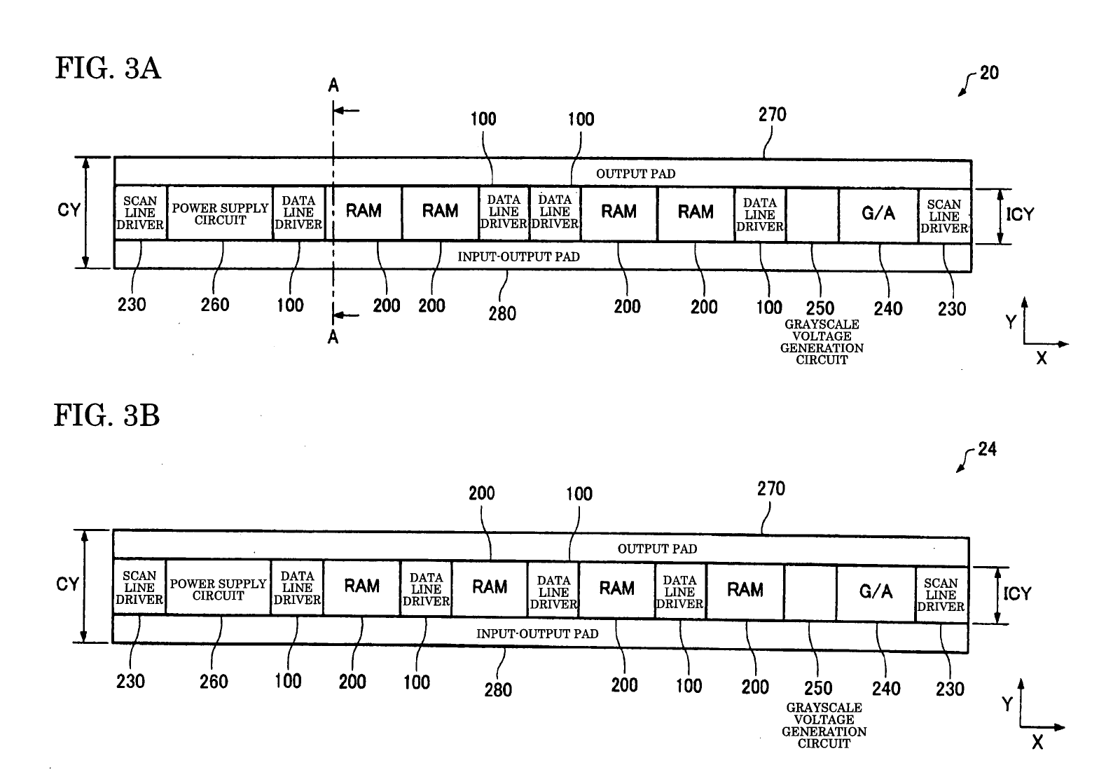

FIGS. 3A and 3B are diagrams showing a layout configuration example of the display driver 20 of the embodiment. As shown in FIG. 3A, the display driver 20 includes a data line driver 100 (data line driver block in a broad sense), a RAM 200 (integrated circuit device or RAM block in a broad sense), a scan line driver 230, a G/A circuit 400 (gate array circuit; automatic routing circuit in a broad sense), a grayscale voltage generation circuit 250, and a power supply circuit 260 disposed along the direction X. These circuits are disposed within a block width ICY of the display driver 20. An output PAD 270 and an input-output PAD 280 are provided in the display driver 20 with these circuits interposed therebetween. The output PAD 270 and the input-output PAD 280 are formed along the direction X. The output PAD 270 is provided on the side of the display region 12. A signal line for supplying control information from a host (e.g. MPU, baseband engine (BBE), MGE, or CPU), a power supply line, and the like are connected with the input-output PAD 280, for example.

The data lines of the display panel 10 are divided into a plurality of (e.g. four) blocks, and one data line driver 100 drives the data lines for one block.

It is possible to flexibly meet the user's needs by providing the block width ICY and disposing each circuit within the block width ICY. In more detail, since the number of data lines which drive the pixels is changed when the number of pixels PX of the drive target display panel 10 in the direction X is changed, it is necessary to design the data line driver 100 and the RAM 200 corresponding to such a change in the number of data lines. In a display driver for a low-temperature polysilicon (LTPS) TFT panel, since the scan driver 230 can be formed on the glass substrate, the scan line driver 230 may not be provided in the display driver 20.

In the embodiment, the display driver 20 can be designed merely by changing the data line driver 100 and the RAM 200 or removing the scan line driver 230. Therefore, since it is unnecessary to newly design the display driver 20 by utilizing the original layout, design cost can be reduced.

In FIG. 3A, two RAMs 200 are disposed adjacent to each other. This enables a part of the circuits used for the RAM 200 to be used in common, whereby the area of the RAM 200 can be reduced. The detailed effects are described later. In the embodiment, the display driver is not limited to the display driver 20 shown in FIG. 3A. For example, the data line driver 100 and the RAM 200 may be adjacent to each other and two RAMs 200 may not be disposed adjacent to each other, as in a display driver 24 shown in FIG. 3B.

In FIGS. 3A and 3B, four data line drivers 100 and four RAMs 200 are provided as an example. The number of data lines driven in one horizontal scan period (also called “1 H period”) can be divided into four by providing four data line drivers 100 and four RAMs 200 (4BANK) in the display driver 20. When the number of pixels PX is 240, it is necessary to drive 720 data lines in the 1 H period taking the R subpixel, G subpixel, and B subpixel into consideration, for example. In the embodiment, it suffices that each data line driver 100 drive 180 data lines which are ¼ of the 720 data lines. The number of data lines driven by each data line driver 100 can be reduced by increasing the number of BANKs. The number of BANKs is defined as the number of RAMs 200 provided in the display driver 20. The total storage area of the RAMs 200 is defined as the storage area of a display memory. The display memory may store at least data for displaying an image for one frame of the display panel 10.

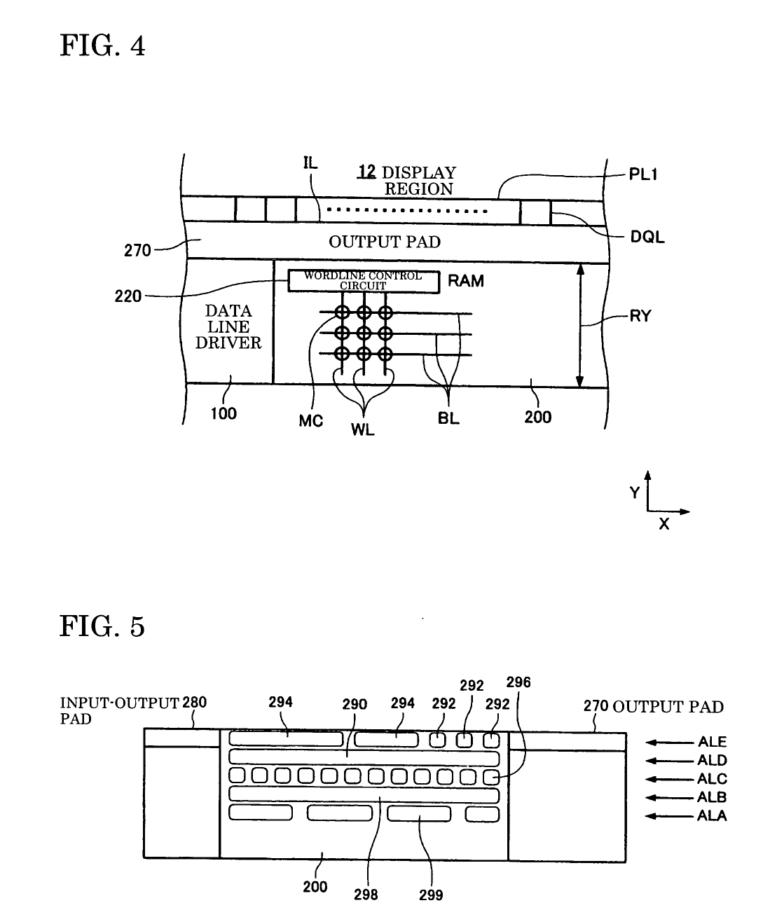

FIG. 4 is an enlarged diagram of a part of the display panel 10 on which the display driver 20 is mounted. The display region 12 is connected with the output PAD 270 of the display driver 20 through interconnects DQL. The interconnect may be an interconnect provided on the glass substrate, or may be an interconnect formed on a flexible substrate or the like and connects the output PAD 270 with the display region 12.

The dimension of the RAM 200 in the direction Y is set at RY. In the embodiment, the dimension RY is set to be equal to the block width ICY shown in FIG. 3A. However, the invention is not limited thereto. For example, the dimension RY may be set to be equal to or less than the block width ICY.

The RAM 200 having the dimension RY includes a plurality of wordlines WL and a wordline control circuit 220 which controls the wordlines WL. The RAM 200 includes a plurality of bitlines BL, a plurality of memory cells MC, and a control circuit (not shown) which controls the bitlines BL and the memory cells MC. The bitlines BL of the RAM 200 are provided parallel to the direction X. Specifically, the bitlines BL are provided parallel to the side PL1 of the display region 12. The wordlines WL of the RAM 200 are provided parallel to the direction Y Specifically, the wordlines WL are provided parallel to the interconnects DQL.

Data is read from the memory cell MC of the RAM 200 by controlling the wordline WL, and the data read from the memory cell MC is supplied to the data line driver 100. Specifically, when the wordline WL is selected, data stored in the memory cells MC arranged along the direction Y is supplied to the data line driver 100.

FIG. 5 is a cross-sectional diagram showing the cross section A-A shown in FIG. 3A. The cross section A-A is the cross section in the region in which the memory cells MC of the RAM 200 are arranged. For example, five metal interconnect layers are provided in the region in which the RAM 200 is formed. A first metal interconnect layer ALA, a second metal interconnect layer ALB, a third metal interconnect layer ALC, a fourth metal interconnect layer ALD, and a fifth metal interconnect layer ALE are illustrated in FIG. 5. A grayscale voltage interconnect 292 to which a grayscale voltage is supplied from the grayscale voltage generation circuit 250 is formed in the fifth metal interconnect layer ALE, for example. A power supply interconnect 294 for supplying a voltage supplied from the power supply circuit 260, a voltage supplied from the outside through the input-output PAD 280, or the like is also formed in the fifth metal interconnect layer ALE. The RAM 200 of the embodiment may be formed without using the fifth metal interconnect layer ALE, for example. Therefore, various interconnects can be formed in the fifth metal interconnect layer ALE as described above.

A shield layer 290 is formed in the fourth metal interconnect layer ALD. This enables effects exerted on the memory cells MC of the RAM 200 to be reduced even if various interconnects are formed in the fifth metal interconnect layer ALE in the upper layer of the memory cells MC of the RAM 200. A signal interconnect for controlling the control circuit for the RAM 200, such as the wordline control circuit 220, may be formed in the fourth metal interconnect layer ALD in the region in which the control circuit is formed.

An interconnect 296 formed in the third metal interconnect layer ALC may be used as the bitline BL or a voltage VSS interconnect, for example. An interconnect 298 formed in the second metal interconnect layer ALB may be used as the wordline WL or a voltage VDD interconnect, for example. An interconnect 299 formed in the first metal interconnect layer ALA may be used to connect with each node formed in a semiconductor layer of the RAM 200.

The wordline interconnect may be formed in the third metal interconnect layer ALC, and the bitline interconnect may be formed in the second metal interconnect layer ALB, differing from the above-described configuration.

As described above, since various interconnects can be formed in the fifth metal interconnect layer ALE of the RAM 200, various types of circuit blocks can be arranged along the direction X as shown in FIGS. 3A and 3B.

2. Data Line Driver

2.1 Configuration of Data Line Driver

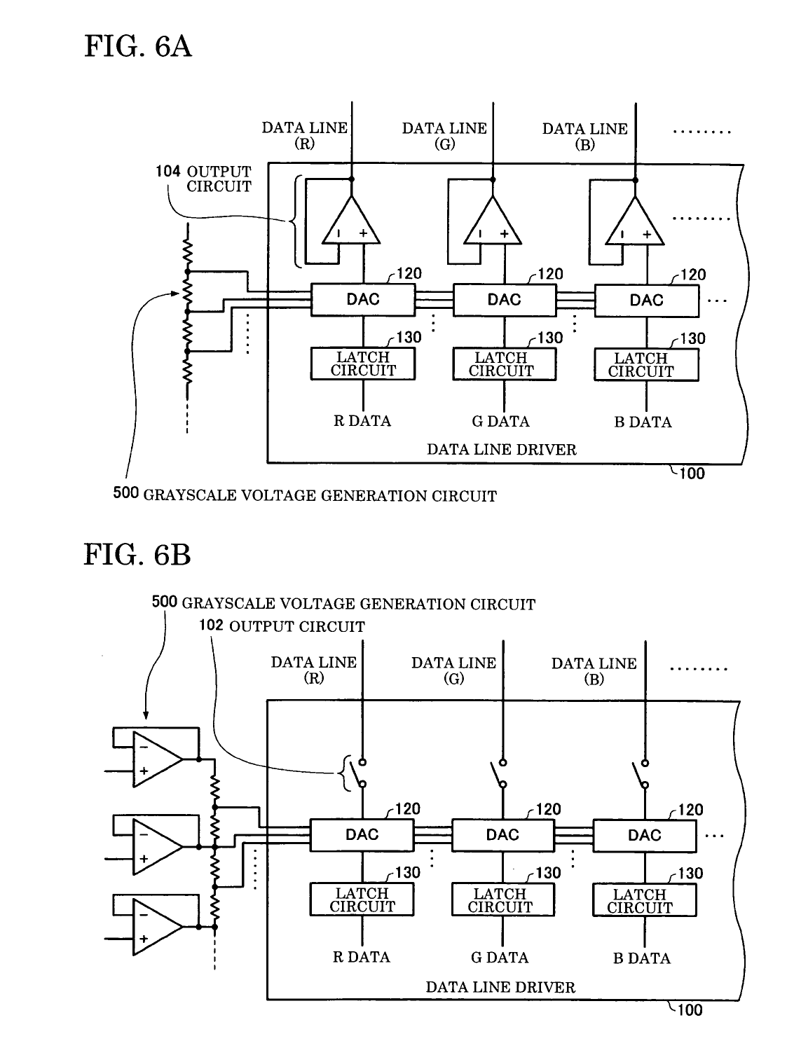

FIG. 6A is a diagram showing the data line driver 100. The data line driver 100 includes an output circuit 104, a DAC 120, and a latch circuit 130. The DAC 120 supplies the grayscale voltage to the output circuit 104 based on data latched by the latch circuit 130. The data supplied from the RAM 200 is stored in the latch circuit 130, for example. When the grayscale is set at G bits, G-bit data is stored in each latch circuit 130, for example. A plurality of grayscale voltages are generated according to the grayscale, and supplied to the data line driver 100 from the grayscale voltage generation circuit 500. For example, the grayscale voltages supplied to the data line driver 100 are supplied to the DAC 120. The DAC 120 selects the corresponding grayscale voltage from the grayscale voltages supplied from the grayscale voltage generation circuit 500 based on the G-bit data latched by the latch circuit 130, and outputs the selected grayscale voltage to the output circuit 104.

The output circuit 104 is formed by an operational amplifier, for example. However, the invention is not limited thereto. As shown in FIG. 6B, an output circuit 102 may be provided in the data line driver 100 instead of the output circuit 104. In this case, a plurality of operational amplifiers are provided in the grayscale voltage generation circuit 500.

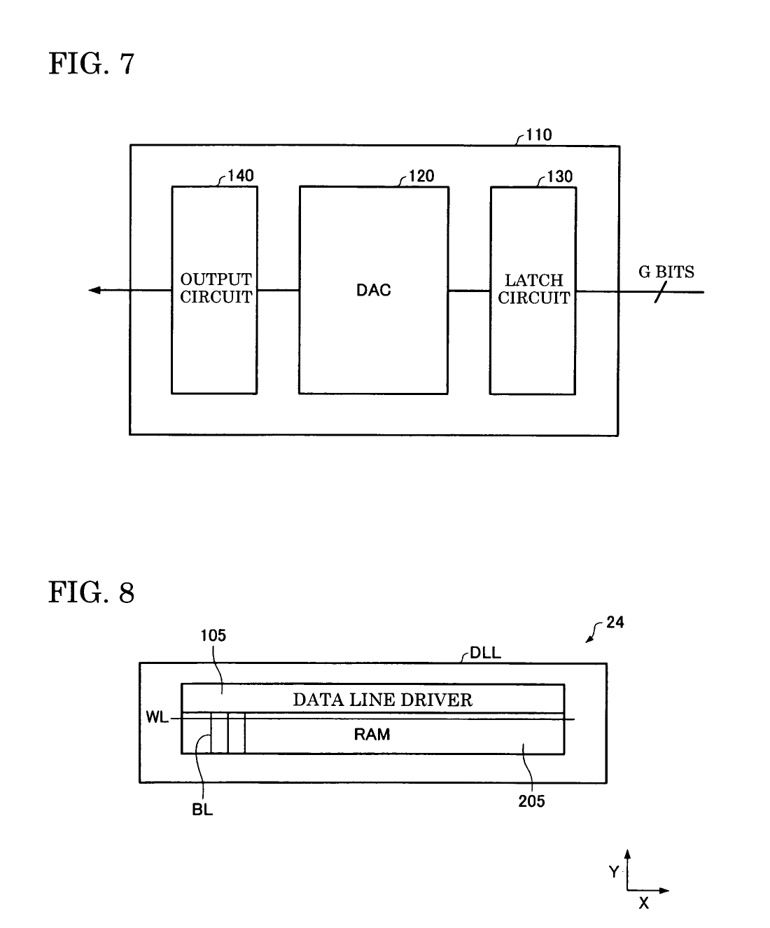

FIG. 7 is a diagram showing a plurality of data line driver cells 110 provided in the data line driver 100. The data line driver 100 drives the data lines, and the data line driver cell 110 drives one of the data lines. For example, the data line driver cell 110 drives one of the R subpixel, the G subpixel, and the B subpixel which make up one pixel. Specifically, when the number of pixels PX in the direction X is 240, 720 (=240×3) data line driver cells 110 in total are provided in the display driver 20. In the 4BANK configuration, 180 data line driver cells 110 are provided in each data line driver 100.

The data line driver cell 110 includes an output circuit 140, the DAC 120, and the latch circuit 130, for example. However, the invention is not limited thereto. For example, the output circuit 140 may be provided outside the data line driver cell 110. The output circuit 140 may be either the output circuit 104 shown in FIG. 6A or the output circuit 102 shown in FIG. 6B.

When the grayscale data indicating the grayscales of the R subpixel, the G subpixel, and the B subpixel is set at G bits, G-bit data is supplied to the data line driver cell 110 from the RAM 200. The latch circuit 130 latches the G-bit data. The DAC 120 outputs the grayscale voltage through the output circuit 140 based on the output from the latch circuit 130. This enables the data line provided in the display panel 10 to be driven.

2.2 Plurality of Readings in One Horizontal Scan Period

FIG. 8 shows a display driver 24 of a comparative example according to the embodiment. The display driver 24 is mounted so that a side DLL of the display driver 24 faces the side PL1 of the display panel 10 on the side of the display region 12. The display driver 24 includes a RAM 205 and a data line driver 105 of which the dimension in the direction X is greater than the dimension in the direction Y. The dimensions of the RAM 205 and the data line driver 105 in the direction X are increased as the number of pixels PX of the display panels 10 is increased. The RAM 205 includes a plurality of wordlines WL and a plurality of bitlines BL. The wordline WL of the RAM 205 is formed to extend along the direction X, and the bitline BL is formed to extend along the direction Y. Specifically, the wordline WL is formed to be significantly longer than the bitline BL. Since the bitline BL is formed to extend along the direction Y, the bitline BL is parallel to the data line of the display panel 10 and intersects the side PL1 of the display panel 10 at right angles.

The display driver 24 selects the wordline WL once in the 1 H period. The data line driver 105 latches data output from the RAM 205 upon selection of the wordline WL, and drives the data lines. In the display driver 24, since the wordline WL is significantly longer than the bitline BL as shown in FIG. 8, the data line driver 100 and the RAM 205 are longer in the direction X, so that it is difficult to secure space for disposing other circuits in the display driver 24. This hinders a reduction in the chip area of the display driver 24. Moreover, since the design time for securing the space and the like is necessary, a reduction in design cost is made difficult.

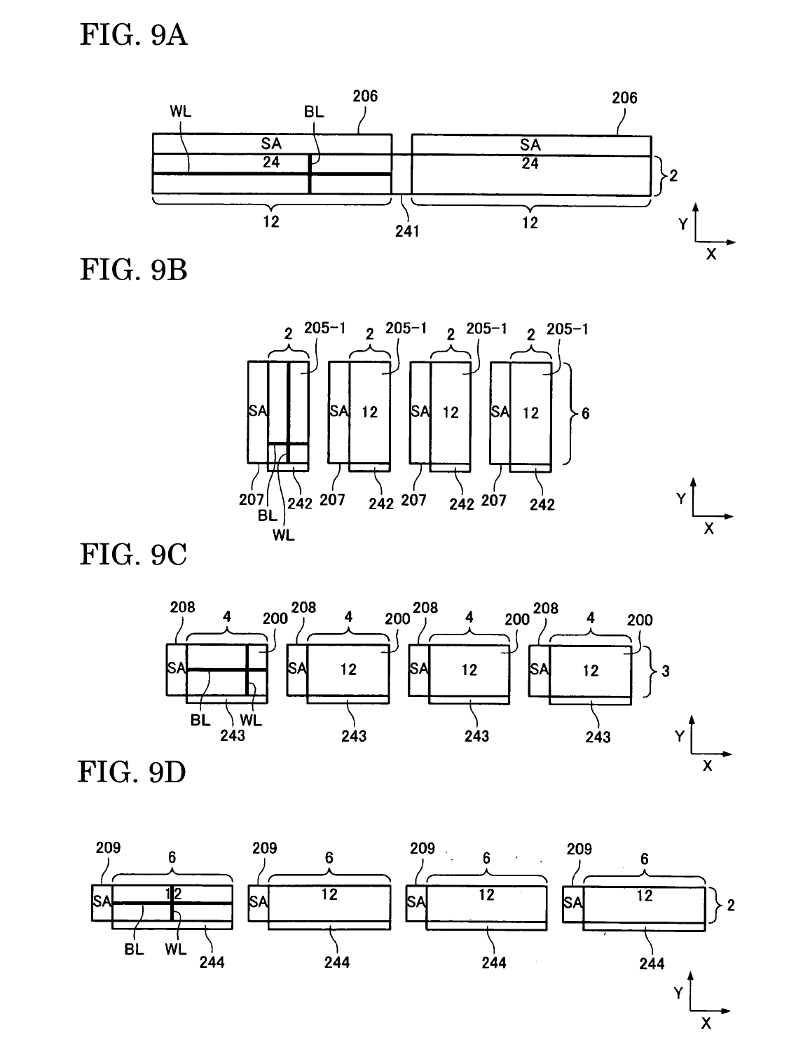

The RAM 205 shown in FIG. 8 is disposed as shown in FIG. 9A, for example. In FIG. 9A, the RAM 205 is divided into two blocks. The dimension of one of the divided blocks in the direction X is “12”, and the dimension in the direction Y is “2”, for example. Therefore, the area of the RAM 205 may be indicated by “48”. These values indicate an example of the ratio which indicates the size of the RAM 205. The actual size is not limited to these values. In FIGS. 9A to 9D, reference numerals 241 to 244 indicate wordline control circuits, and reference numerals 206 to 209 indicate sense amplifiers.

In the embodiment, the RAM 205 may be divided into a plurality of blocks and disposed in a state in which the divided blocks are rotated at 90 degrees. For example, the RAM 205 may be divided into four blocks and disposed in a state in which the divided blocks are rotated at 90 degrees, as shown in FIG. 9B. A RAM 205-1, which is one of the four divided blocks, includes a sense amplifier 207 and the wordline control circuit 242. The dimension of the RAM 205-1 in the direction Y is “6”, and the dimension in the direction X is “2”. Therefore, the area of the RAM 205-1 is “12” so that the total area of the four blocks is “48”. However, since it is desired to reduce the dimension CY of the display driver 20 in the direction Y, the state shown in FIG. 9B is inconvenient.

In the embodiment, the dimension RY of the RAM 200 in the direction Y can be reduced by reading data a plurality of times in the 1 H period, as shown in FIGS. 9C and 9D. FIG. 9C shows an example of reading data twice in the 1 H period. In this case, since the wordline WL is selected twice in the 1 H period, the number of memory cells MC arranged in the direction Y can be halved, for example. This enables the dimension of the RAM 200 in the direction Y to be reduced to “3”, as shown in FIG. 9C. The dimension of the RAM 200 in the direction X is increased to “4”. Specifically, the total area of the RAM 200 becomes “48”, so that the RAM 200 becomes equal to the RAM 205 shown in FIG. 9A as to the area of the region in which the memory cells MC are arranged. Since the RAM 200 can be freely disposed as shown in FIGS. 3A and 3B, a very flexible layout becomes possible, whereby an efficient layout can be achieved.

FIG. 9D shows an example of reading data three times. In this case, the dimension “6” of the RAM 205-1 shown in FIG. 9B in the direction Y can be reduced by ⅓. Specifically, the dimension CY of the display driver 20 in the direction Y can be reduced by adjusting the number of readings in the 1 H period.

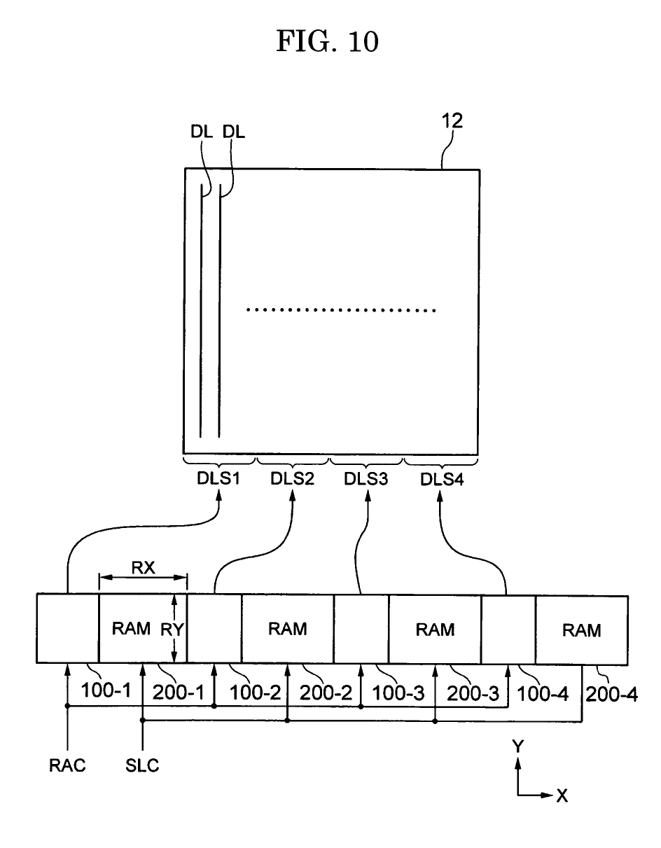

In the embodiment, the RAM 200 divided into blocks can be provided in the display driver 20 as described above. In the embodiment, the 4BANK RAMs 200 can be provided in the display driver 20, for example. In this case, data line drivers 100-1 to 100-4 corresponding to each RAM 200 drive the corresponding data lines DL as shown in FIG. 10.

In more detail, the data line driver 100-1 drives a data line group DLS1, the data line driver 100-2 drives a data line group DLS2, the data line driver 100-3 drives a data line group DLS3, and the data line driver 100-4 drives a data line group DLS4. Each of the data line groups DLS1 to DLS4 is one of four blocks into which the data lines DL provided in the display region 12 of the display panel 10 are divided, for example. The data lines of the display panel 10 can be driven by providing four data line drivers 100-1 to 100-4 corresponding to the 4BANK RAM 200 and causing the data line drivers 100-1 to 100-4 to drive the corresponding data lines.

2.3 Divided Structure of Data Line Driver

The dimension RY of the RAM 200 shown in FIG. 4 in the direction Y may depend not only on the number of memory cells MC arranged in the direction Y, but also on the dimension of the data line driver 100 in the direction Y

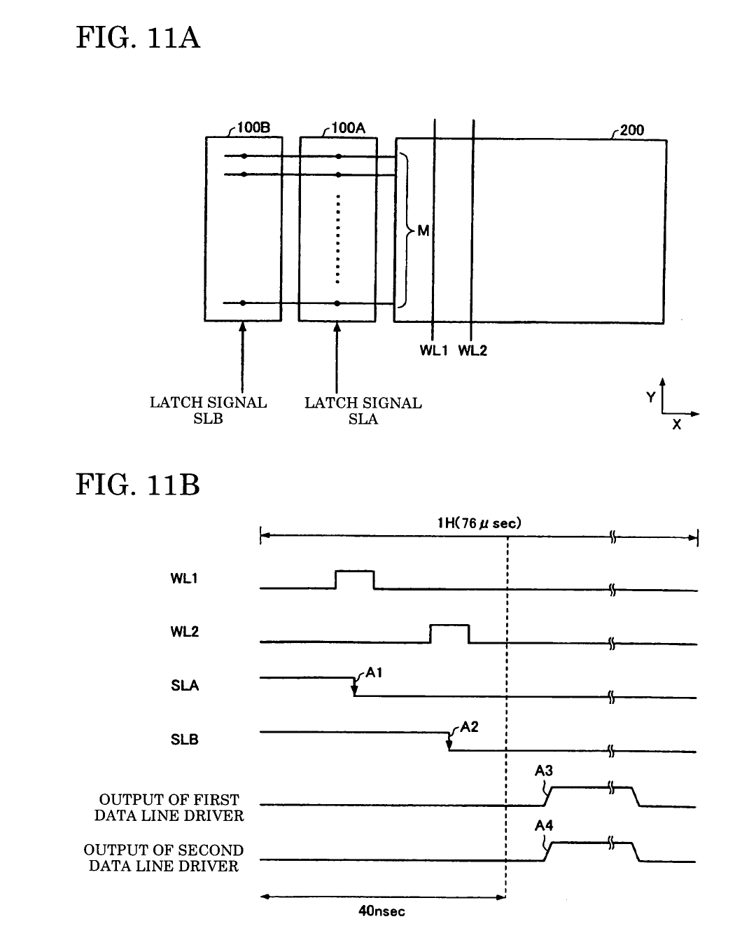

In the embodiment, on the premise that data is read a plurality of times (e.g. twice) in one horizontal scan period in order to reduce the dimension RY of the RAM 200 shown in FIG. 4, the data line driver 100 is formed to have a divided structure consisting of a first data line driver 100A (first divided data line driver in a broad sense) and a second data line driver 100B (second divided data line driver in a broad sense), as shown in FIG. 11A. A reference character “M” shown in FIG. 11A indicates the number of bits of data read from the RAM 200 by one wordline selection.

For example, when the number of pixels PX is 176, the grayscale of the pixel is 18 bits, and the number of BANKs of the RAM 200 is four (4BANK), 792 (=176×18÷4) bits of data must be output from each RAM 200 when reading data only once in the 1 H period.

However, it is desired to reduce the dimension RY of the RAM 200 in order to reduce the chip area of the display driver 100. Therefore, as shown in FIG. 11A, the data line driver 100 is divided into the data line drivers 100A and 100B in the direction X on the premise that data is read twice in the 1 H period, for example. This enables M to be set at 396 (=792÷2) so that the dimension RY of the RAM 200 can be approximately halved.

The data line driver 100A drives a part of the data lines of the display panel 10. The data line driver 100B drives a part of the data lines of the display panel 10 other than the data lines driven by the data line driver 100A. As described above, the data line drivers 100A and 100B cooperate to drive the data lines of the display panel 10.

In more detail, the wordlines WL1 and WL2 are selected in the 1 H period as shown in FIG. 11B, for example. Specifically, the wordlines are selected twice in the 1 H period. A latch signal SLA falls at a timing A1. The latch signal SLA is supplied to the data line driver 100A, for example. The data line driver 100A latches M-bit data supplied from the RAM 200 in response to the falling edge of the latch signal SLA, for example.

A latch signal SLB falls at a timing A2. The latch signal SLB is supplied to the data line driver 100B, for example. The data line driver 100B latches M-bit data supplied from the RAM 200 in response to the falling edge of the latch signal SLB, for example.

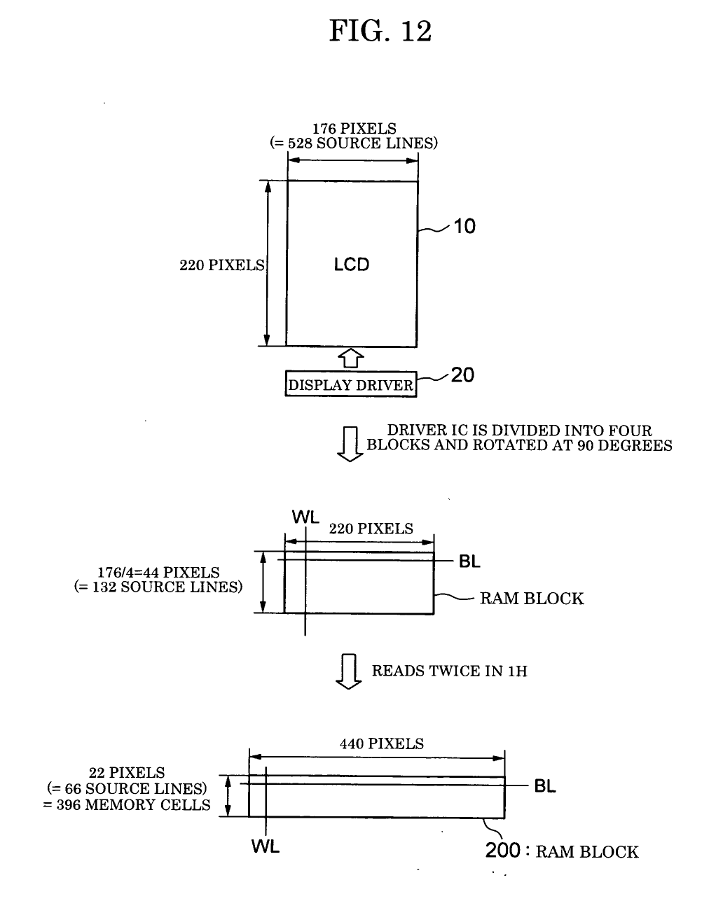

In more detail, data stored in a memory cell group MCS1 (M memory cells) is supplied to the data line drivers 100A and 100B through a sense amplifier circuit 210 upon selection of the wordline WL1, as shown in FIG. 12. However, since the latch signal SLA falls in response to the selection of the wordline WL1, the data stored in the memory cell group MCS1 (M memory cells) is latched by the data line driver 100A.

Upon selection of the wordline WL2, data stored in a memory cell group MCS2 (M memory cells) is supplied to the data line drivers 100A and 100B through the sense amplifier circuit 210. The latch signal SLB falls in response to the selection of the wordline WL2. Therefore, the data stored in the memory cell group MCS2 (M memory cells) is latched by the data line driver 100B.

For example, when M is set at 396 bits, M=396 bits of data is latched by each of the data line drivers 100A and 100B, since the data is read twice in the 1 H period. Specifically, 792 bits of data in total is latched by the data line driver 100 so that 792 bits necessary for the above-described example can be latched in the 1 H period. Therefore, the amount of data necessary in the 1 H period can be latched, and the dimension RY of the RAM 200 can be approximately halved. This enables the block width ICY of the display driver 20 to be reduced, whereby the manufacturing cost of the display driver 20 can be reduced.

FIGS. 11A and 11B illustrate an example of reading data twice in the 1 H period. However, the invention is not limited thereto. For example, data may be read four or more times in the 1 H period. When reading data four times, the data line driver 100 may be divided into four blocks so that the dimension RY of the RAM 200 can be further reduced. In this case, M may be set at 198 in the above-described example, and 198-bit data is latched by each of the four divided data line drivers. Specifically, 792 bits of data necessary in the 1 H period can be supplied while reducing the dimension RY of the RAM 200 by approximately ¼.

The outputs of the data line drivers 100A and 100B may be caused to rise based on control by using a data line enable signal (not shown) or the like as indicated by A3 and A4 shown in FIG. 11B, or the data latched by the data line drivers 100A and 100B at the timings A1 and A2 may be directly output to the data lines. An additional latch circuit may be provided to each of the data line drivers 100A and 100B, and voltages based on the data latched at the timings A1 and A2 may be output in the next 1 H period. This enables the number of readings in the 1 H period to be increased without causing the image quality to deteriorate.

When the number of pixels PY is 220 (the number of scan lines of the display panel 10 is 220) and 60 frames are displayed within one second, the 1 H period is about 52 μs as shown in FIG. 11B. The 1 H period is calculated as indicated by “1 sec÷60 frames÷220≈76 μs”. As shown in FIG. 11B, the wordlines are selected within about 40 nsec. Specifically, since the wordlines are selected (data is read from the RAM 200) a plurality of times within a period sufficiently shorter than the 1 H period, deterioration of the image quality of the display panel 10 does not occur.

The value M can be obtained by using the following equation, when BNK denotes the number of BANKs, N denotes the number of readings in the 1 H period, and “the number of pixels PX×3” means the number of pixels (or the number of subpixels in the embodiment) corresponding to the data lines of the display panel 10 and coincides with the number of data lines DLN:

$$M = \frac{DLN \times G}{BNK \times N}$$

In the embodiment, the sense amplifier circuit 210 has a latch function. However, the invention is not limited thereto.

3. Specific Example of Source Driver and RAM Block

The data driver 100 and the RAM block 200 which allow the display driver 10 used for the 176×220-pixel color liquid crystal display panel 10 to be divided into four blocks and rotated at 90 degrees and allow data to be read twice in one horizontal scan period, as shown in FIG. 12, are described below in detail.

3.1 RAM Integrated Data Driver Block

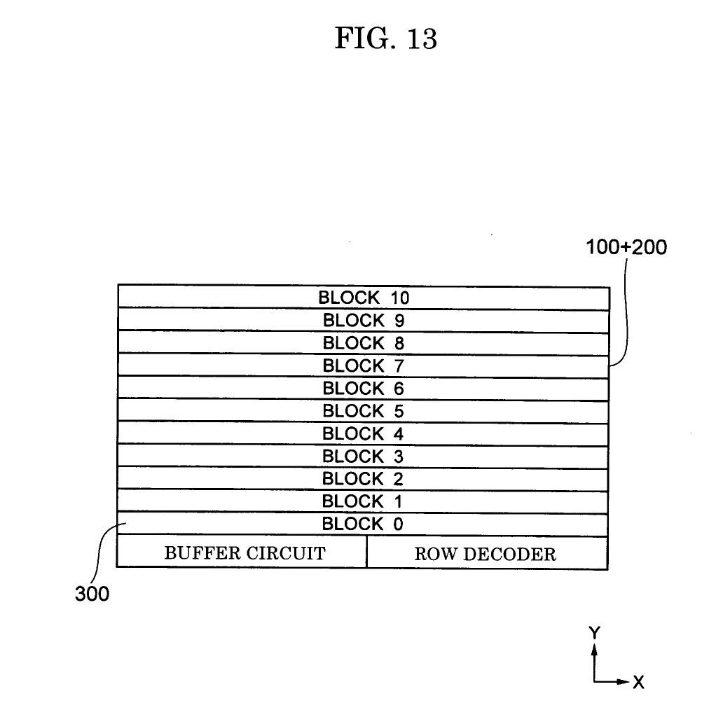

FIG. 13 shows a block of the source driver 100 and the RAM block 200. This block is divided into eleven RAM integrated data driver blocks 300 in the direction Y in which the wordline extends. Since the RAM block 200 stores data of 22 pixels in the direction Y, as shown in FIG. 12, the RAM integrated data driver block 300 obtained by dividing the RAM block 200 into eleven blocks stores data of two pixels in the direction Y.

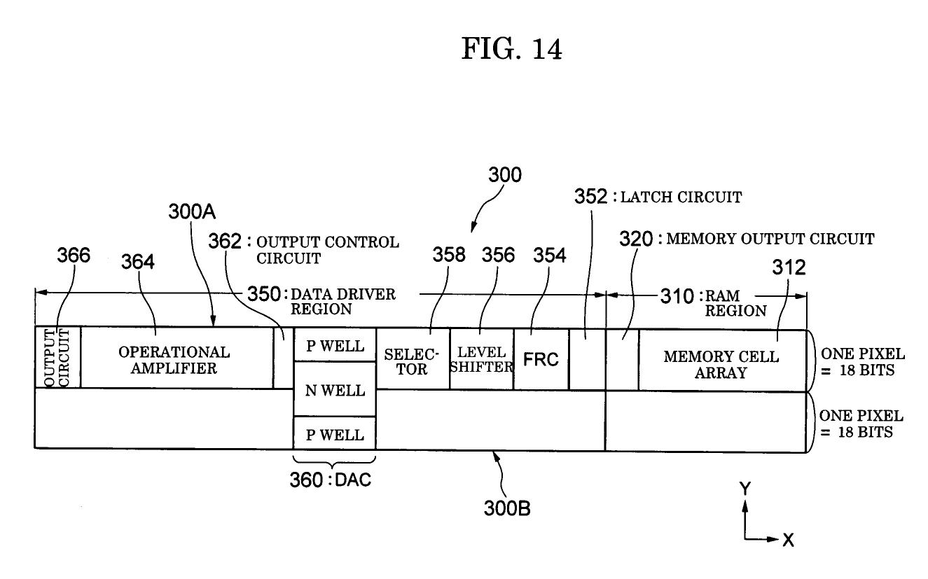

As shown in FIG. 14, the RAM integrated data block 300 is roughly divided into a RAM region 310 and a data driver region 350 in the direction X. A memory cell array 312 and a memory output circuit 320 are provided in the RAM region 310. The data driver region 350 includes a latch circuit 352, a frame rate controller (FRC) 354, a level shifter 356, a selector 358, a digital-analog converter (DAC) 360, an output control circuit 362, an operational amplifier 364, and an output circuit 366. The RAM integrated data driver block 300 which outputs data of two pixels is divided into subblocks 300A and 300B in pixel data units. The circuits of the subblocks 300A and 300B are disposed in a mirror image across the boundary between the subblocks 300A and 300B. As shown in FIG. 14, a P-well/N-well structure in a one-pixel conversion region in which data of one pixel is digital-analog converted is disposed in a mirror image in the region of the DAC 360 across the boundary between the subblocks 300A and 330B. This is because N-type and P-type transistors forming switches necessary for the DAC can be arranged on a straight line in the direction Y. Therefore, since the N-type well can be used in common by the subblocks 300A and 330B, the number of well isolation regions is reduced, whereby the dimension in the direction Y can be reduced. Specifically, the dimension RY shown in FIG. 10 can be reduced.

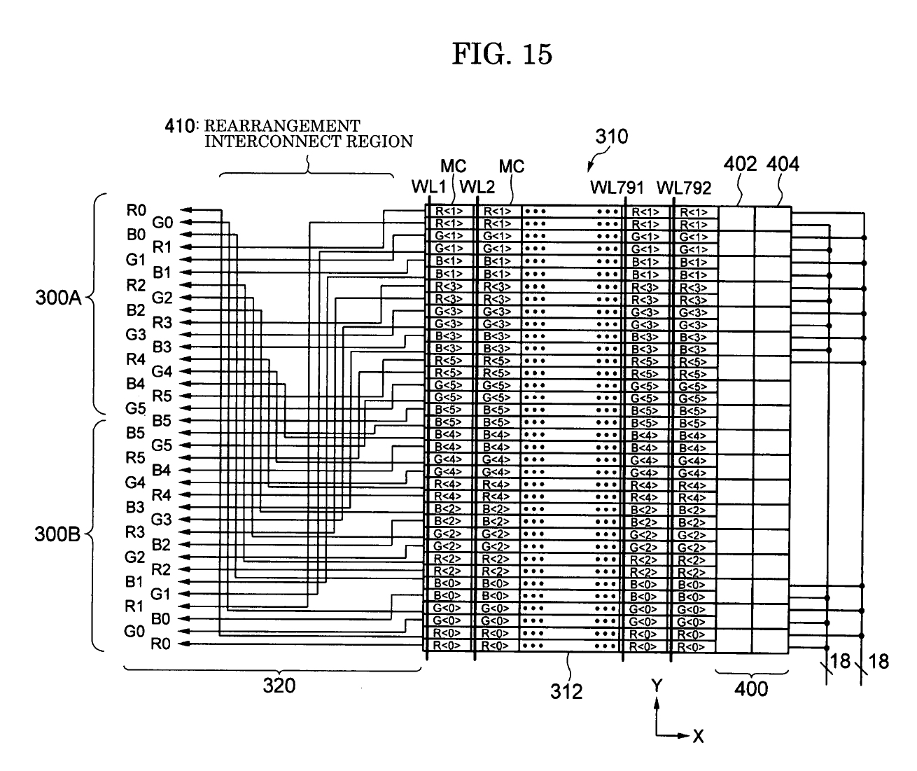

FIG. 15 shows the RAM region 310 of the RAM integrated data driver block 300 shown in FIG. 14. In the RAM region 310, 36 memory cells MC of two pixels (i.e. 2 (pixel)×3 (RGB)×6 (number of grayscale bits)=36 bits) are arranged in the direction Y As shown in FIG. 15, the memory cell MC used in the embodiment is in the shape of a rectangle having a long side parallel to the direction X (bitline direction) and a short side parallel to the direction Y (wordline direction). This allows the height in the direction Y to be reduced when arranging the 36 memory cells MC in the direction Y, whereby the height of the RAM block 200 shown in FIG. 10 can be reduced.

Since the subblocks 300A and 300B of the RAM integrated data driver block 300 are disposed in a mirror image as described with reference to FIG. 14, the inputs to the data driver regions 350 of the subblocks 300A and 300B must be symmetrical across the boundary between the subblocks 300A and 300B, as shown on the left end in FIG. 15.

When the subpixels R, G, and B forming one pixel are respectively six bits, the total number of bits of one pixel is 18. The 18-bit data of one pixel is indicated as R0, B0, G0, . . . , R5, B5, and G5. As shown on the left end in FIG. 15, the output arrangement to the data driver region 350 in the subblock 300A is in the order of R0, G0, B0, R1, . . . , R5, G5, and B5 from the top side. The output arrangement to the data driver region 350 in the subblock 300B is in the order of R0, G0, B0, R1, . . . , R5, G5, and B5 from the bottom side for the above-described reason. In other words, the data of two pixels is symmetrical across the boundary between the subblocks 300A and 300B.

On the other hand, the RGB storage order (i.e. data read order) the shown in FIG. 15 is used in the memory cell array 312 in the RAM region 310 of the RAM integrated data driver block 300, which does not coincide with the data output order to the data driver region 350. Therefore, a rearrangement interconnect region 410 is provided in the region of the memory output circuit 320, as shown in FIG. 15. The rearrangement interconnect region 410 rearranges bit data input from the bitlines in the data read order using interconnects, and outputs the bit data in the bit output order of the memory output circuit 320.

The rearrangement interconnect region 410 is described later. The memory cell array 312 is described below. As shown in FIG. 15, a data read/write circuit 400 which receives and outputs data from and to a host device (not shown) which controls reading and writing of data from and into the RAM block 200 is provided on the right of the memory cell array 312. 18-bit data is input to or output from the data read/write circuit 400 by one access. Specifically, two accesses are necessary in order to read or write 36-bit data of two pixels from or into the RAM integrated data driver block 300.

As shown in FIG. 15, the data read/write circuit 400 includes eighteen write driver cells 402 arranged in the direction Y and eighteen sense amplifier cells 404 arranged in the direction Y When a specific number (two in this embodiment) of memory cells adjacent in the direction Y (wordline direction) is referred to as one memory cell group, each write driver cell 402 has a height equal to the height of two memory cells MC forming one memory cell group in the direction Y. In other words, one write driver cell 402 is used for two adjacent memory cells MC. Similarly, each sense amplifier cell 404 has a height equal to the height of two adjacent memory cells MC in the direction Y. In other words, one sense amplifier cell 404 is used for two adjacent memory cells MC.

An example in which the host device writes data of one pixel into the memory cell array 312 is described below. For example, the wordline WL1 shown in FIG. 15 is selected, and data R0, B0, G0, . . . , R5, B5, and G5 of one pixel is written into even-numbered eighteen memory cells MC among the 36 memory cells MC arranged in the direction Y through 18 write driver cells 402. Then, the wordline WL1 is selected, and data R0, B0, G0, . . . , R5, B5, and G5 of the subsequent pixel is written into odd-numbered eighteen memory cells MC among the 36 memory cells MC arranged in the direction Y through 18 write driver cells 402.

This allows the data of two pixels to be written into the 36 memory cells MC arranged in the direction Y shown in FIG. 15. When reading data into the host device, data is read twice in the same manner as in the write operation using the sense amplifier cells 404 instead of the write driver cells 402.

As described above, two pieces of data (e.g. R0 and R0) of the same color and having the same grayscale bit number of the six bits in total are input to two memory cells MC adjacent in the direction Y in FIG. 15 due to limitations to access from the host device. Therefore, the order of data stored in the 36 memory cells MC arranged in the direction Y in FIG. 15 does not coincide with the data output order illustrated on the left end in FIG. 15. The order of data stored in the 36 memory cells MC arranged in the direction Y in FIG. 15 is determined in order to reduce the number of interconnect intersections in the rearrangement interconnect region 410 to reduce the rearrangement interconnect length.

As described above, the data read order corresponding to the arrangement of the bitlines BL in the memory cell array 312 differs from the data output order from the memory output circuit 320. Therefore, the rearrangement interconnect region 410 shown in FIG. 15 is provided.

3.2 Memory Output Circuit

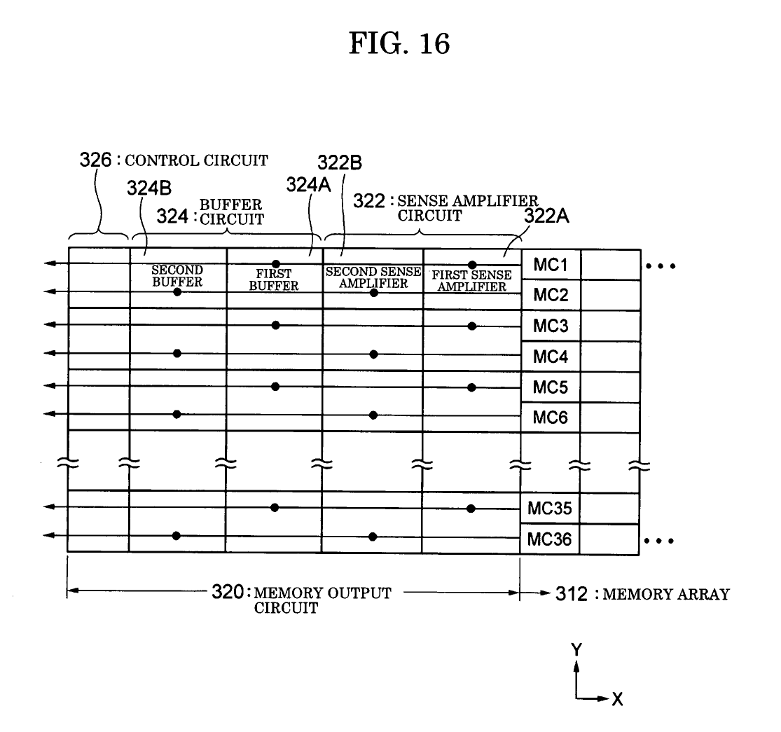

An example of the memory output circuit 320 including the rearrangement interconnect region 410 is described below with reference to FIG. 16. In FIG. 16, the memory output circuit 320 includes a sense amplifier circuit 322, a buffer circuit 324, and a control circuit 326 which controls the sense amplifier circuit 322 and the buffer circuit 324, arranged along the direction X.

The sense amplifier circuit 322 includes L sense amplifier cells (L is an integer larger than 1) in the bitline direction (direction X), such as a first sense amplifier cell 322A and a second sense amplifier cell 322B (L=2), and two pieces of bit data simultaneously read in one horizontal scan period are respectively input to the first sense amplifier cell 322A and the second sense amplifier cell 322B. Therefore, the height of each of the first and second sense amplifier cells 322A and 322B may be within the range of the height of L (L=2) memory cells MC adjacent in the direction X, whereby the degrees of freedom of the circuit layout of the sense amplifier circuit 322 are ensured.

Specifically, when the height of one memory cell MC in the direction Y is MCY and the height of each of the first sense amplifier cell 322A and the second sense amplifier cell 322B (L=2) in the direction Y is SACY, if “(L−1)×MCY<SACY≦L×MCY” is satisfied, the degrees of freedom of the layout of the sense amplifier cells can be ensured while maintaining the height of the integrated circuit device in the direction Y equal to or less than a specific value. L is not limited to two, but may be an integer larger than 1. Note that L is an integer which satisfies “L<M/2”.

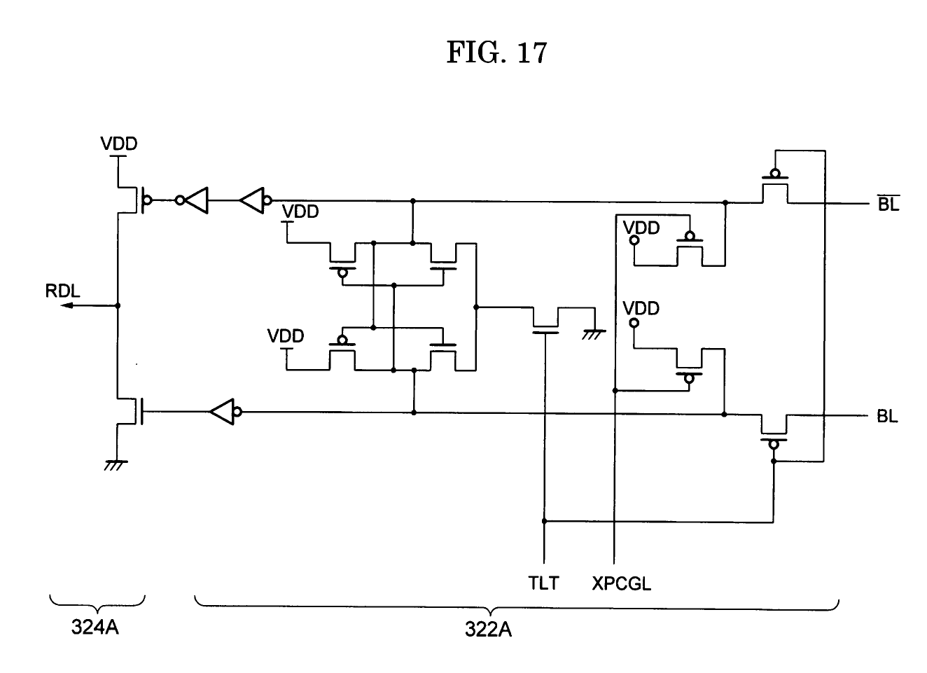

The buffer circuit 324 includes a first buffer cell 324A which amplifies the output from the first sense amplifier cell 322A, and a second buffer cell 324B which amplifies the output from the second sense amplifier cell 322B. In the example shown in FIG. 16, data read from the memory cell MC1 upon selection of the wordline is detected by the first sense amplifier cell 322A, and amplified and output by the first buffer cell 324A. Data read from the memory cell MC2 upon selection of the same wordline is detected by the second sense amplifier cell 322B, and amplified and output by the second buffer cell 324B. FIG. 17 shows an example of the circuit configuration of the first sense amplifier cell 322A and the first buffer cell 324A. The first sense amplifier cell 322A and the first buffer cell 324A are controlled based on signals TLT and XPCGL from the control circuit 326.

3.3 Rearrangement Interconnect Region

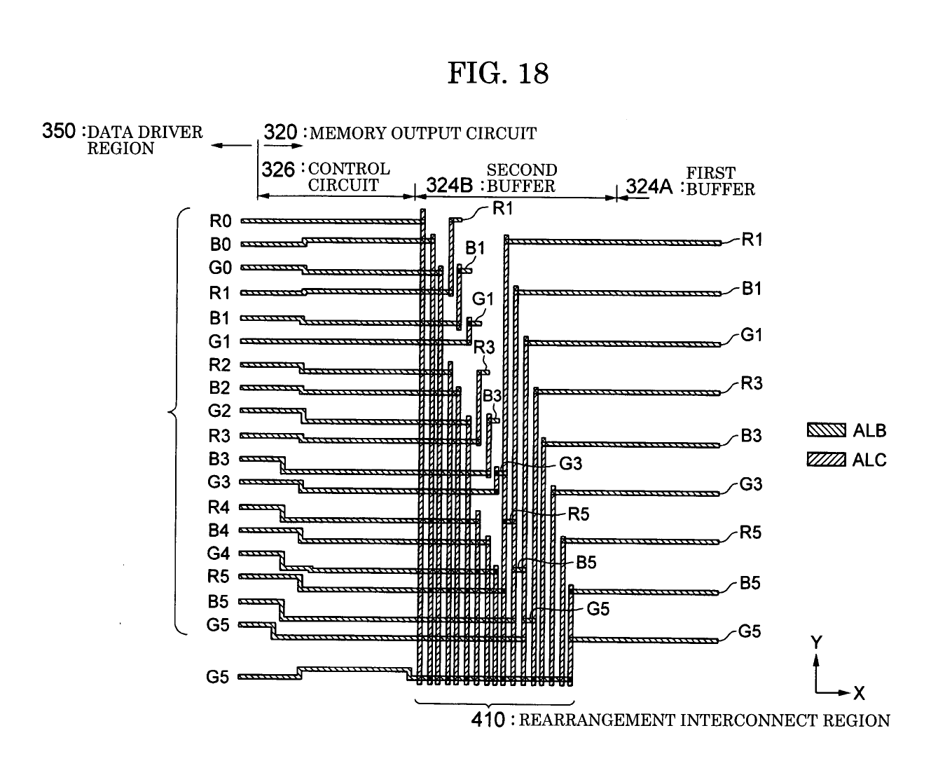

In this embodiment, the rearrangement interconnect region 410 shown in FIG. 15 is disposed in the region of the second buffer cell 324B, as shown in FIG. 18. FIG. 18 mainly shows the subblock 300A shown in FIG. 14, in which output data R1 to B1, R3 to B3, and R5 to B5 from the first buffer cell 324A and output data R1 to B1, R3 to B3, and R5 to B5 from the second buffer cell 324B are illustrated.

Output terminals of the output data R1 to B1, R3 to B3, and R5 to B5 from the first buffer cell 324A are pulled out in the direction X using the second metal layer ALB, pulled out in the direction Y using the third metal layer ALC through vias, and provided toward the subblock 300B.

Output terminals of the output data R1 to B1, R3 to B3, and R5 to B5 from the second buffer cell 324B are pulled out to some extent in the direction X using the second metal layer ALB, pulled out in the direction Y using the third metal layer ALC through vias, pulled out in the direction X using the second metal layer ALB through vias, and connected with output terminals of the memory output circuit 320.

As described above, the desired rearrangement interconnects are realized in the rearrangement interconnect region 410 using the interconnect layer ALB in which a plurality of interconnects extending in the bitline direction are formed, the interconnect layer ALC in which a plurality of interconnects extending in the wordline direction are formed, and the vias which selectively connect the interconnect layers ALB and ALC. The outputs from the first and second buffer cells 324A and 324B can be rearranged within the shortest route by utilizing the region of the second buffer cell 324B, whereby the interconnect load can be reduced.

4. Electronic Instrument

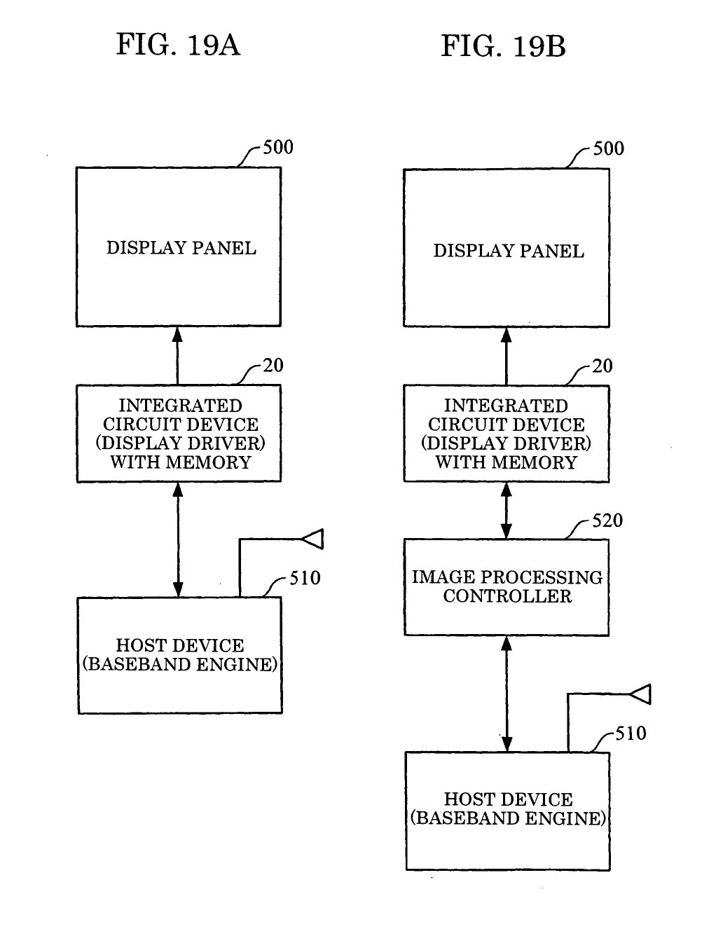

FIGS. 19A and 19B illustrate examples of an electronic instrument (electro-optical device) including the integrated circuit device 20 according to the above embodiment. The electronic instrument may include constituent elements (e.g. camera, operation section, or power supply) other than the constituent elements shown in FIGS. 19A and 19B. The electronic instrument according to this embodiment is not limited to a portable telephone, but may be a digital camera, PDA, electronic notebook, electronic dictionary, projector, rear-projection television, portable information terminal, or the like.

In FIGS. 19A and 19B, a host device 510 is a microprocessor unit (MPU), a baseband engine (baseband processor), or the like. The host device 510 controls the integrated circuit device 20 which is a display driver. The host device 510 may perform processing as an application engine and a baseband engine or processing as a graphic engine such as compression, decompression, and sizing. An image processing controller (display controller) 520 shown in FIG. 19B performs processing as a graphic engine such as compression, decompression, or sizing instead of the host device 510.

A display panel 500 includes a plurality of data lines (source lines), a plurality of scan lines (gate lines), and a plurality of pixels specified by the data lines and the scan lines. A display operation is realized by changing the optical properties of an electro-optical element (liquid crystal element in a narrow sense) in each pixel region. The display panel 500 may be formed by an active matrix type panel using switching elements such as a TFT or TFD. The display panel 500 may be a panel other than an active matrix type panel, or may be a panel other than a liquid crystal panel.

In FIG. 19A, the integrated circuit device 20 may include a memory. In this case, the integrated circuit device 20 writes image data from the host device 510 into the built-in memory, and reads the written image data from the built-in memory to drive the display panel. In FIG. 19B, the integrated circuit device 20 may include a memory. In this case, image data from the host device 510 may be image-processed using a memory provided in the image processing controller 520. The processed data is stored in the memory of the integrated circuit device 20, whereby the display panel 500 is driven.

5. Modification

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings.

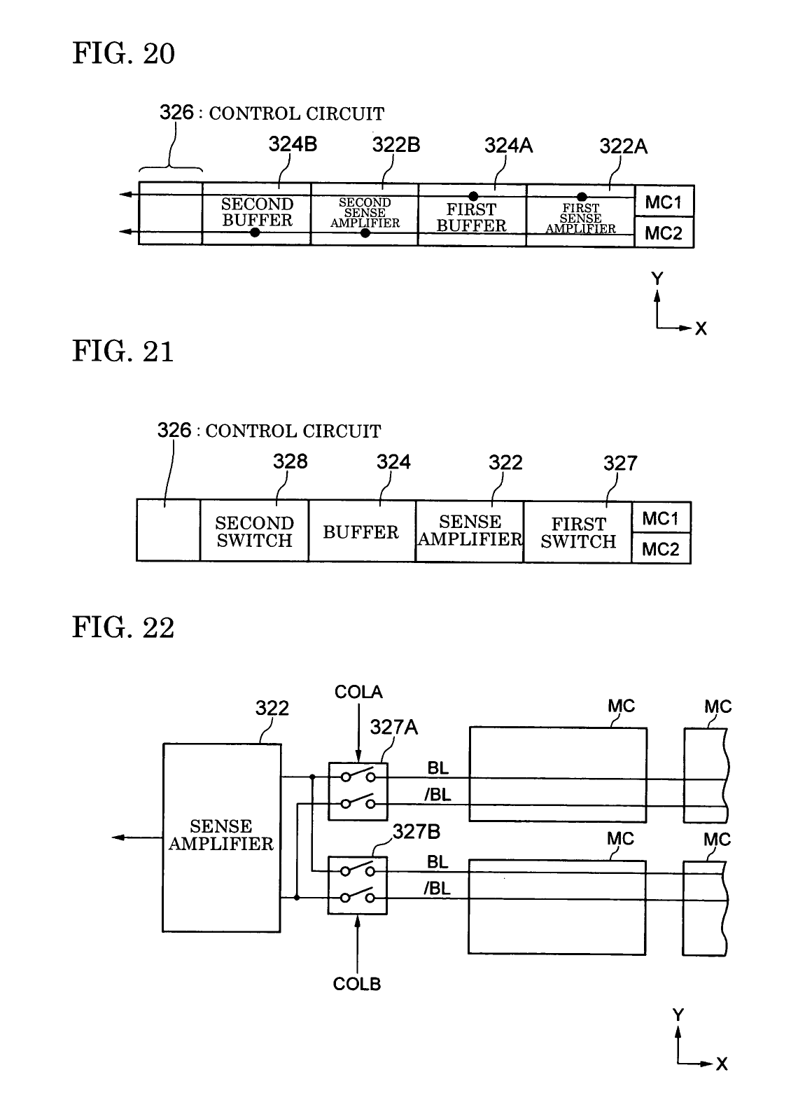

FIG. 20 shows a memory output circuit differing from that shown in FIG. 16. In FIG. 20, the first sense amplifier cell 322A, the first buffer cell 324A, the second sense amplifier cell 324B, the second buffer cell 324B, and the control circuit 326 are arranged in that order in the direction X. In this case, the rearrangement interconnect region 410 can also be disposed in the region of the memory output circuit, in particular the region of the second buffer cell 324B.

In the example shown in FIG. 21, the sense amplifier 322 and the buffer 324 are not divided corresponding to the number of readings N in one horizontal scan period. In this case, a first switch 327 is provided in the preceding stage of the sense amplifier 322, and a second switch 328 is provided in the subsequent stage of the buffer 324. As shown in FIG. 22, the first switch 327 includes two switches 327A and 327B exclusively selected using column address signals COLA and COLB. This allows one sense amplifier 322 and one buffer 324 to be used for two memory cells MC. The second switch 328 is switched in the same manner as the first switch 327 and selectively outputs data transmitted from two memory cells MC by time division to two output lines. In the example shown in FIG. 21, the rearrangement interconnect region 410 can also be disposed in the region of the memory output circuit.

In the above embodiment, the rearrangement interconnect region 410 is provided taking into consideration the layout of the memory cells determined due to data access between the host device and the memory cell array and the mirror-image arrangement of the circuit structure in the data driver. Note that rearrangement may be carried out taking into consideration one of these factors or a factor differing from these factors.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. An integrated circuit device having a data memory which includes a memory cell array including a plurality of wordlines, a plurality of bitlines, and a plurality of memory cells, and a memory output circuit,
wherein data read order in the memory cell array corresponding to arrangement of the bitlines differs from data output order from the memory output circuit;
wherein the integrated circuit device includes a rearrangement interconnect region in a region of the memory output circuit; and
wherein the rearrangement interconnect region rearranges data input in the data read order using interconnects and outputs the data in the data output order.

2. The integrated circuit device as defined in claim 1,
wherein the rearrangement interconnect region includes:
a first interconnect layer having a plurality of first interconnects extending along a first direction in which the bitlines extend;
a second interconnect layer having a plurality of second interconnects extending along a second direction in which the wordlines extend; and
a plurality of vias selectively connecting the first interconnects with the second interconnects between the first and second interconnect layers.

3. The integrated circuit device as defined in claim 1,
wherein the memory output circuit includes:
a sense amplifier which detects one-bit data output from each of the bitlines; and
a buffer which amplifies an output from the sense amplifier; and
wherein the rearrangement interconnect region is disposed in a formation region of the buffer.

4. The integrated circuit device as defined in claim 3,
wherein the sense amplifier is located on an end in the first direction in which the bitlines extend and includes L sense amplifier cells in the first direction adjacent to L memory cells adjacent in the second direction in which the wordlines extend (L is an integer larger than 1); and
wherein data read from the L memory cells is respectively input to the L sense amplifier cells.

5. The integrated circuit device as defined in claim 4,
wherein the buffer includes L buffer cells which respectively amplify outputs from the L sense amplifier cells.

6. The integrated circuit device as defined in claim 5,
wherein the L sense amplifier cells are adjacently disposed in the first direction; and
wherein the L buffer cells are disposed adjacent to the L sense amplifier cells in a subsequent stage of the L sense amplifier cells.

7. The integrated circuit device as defined in claim 6,
wherein the rearrangement interconnect region is disposed in a region including a final-stage buffer cell of the L buffer cells.

8. The integrated circuit device as defined in claim 3, further comprising:
a data read/write circuit which receives data from and outputs data to a host device which controls reading and writing of data from and into the memory cells;
wherein the data read order of the bitlines is set corresponding to circuit arrangement in the data read/write circuit.

9. The integrated circuit device as defined in claim 8,
wherein, when a specific number of memory cells adjacent in the second direction is referred to as one memory cell group, the data read/write circuit includes read sense amplifiers provided corresponding to each of the memory cell groups and data write cells provided corresponding to each of the memory cell groups; and
wherein the data read order from the memory cells is determined corresponding to data stored in each of the memory cell groups.

10. The integrated circuit device as defined in claim 3, further comprising:
a data line driver circuit which drives the data lines based on outputs from the memory output circuit;
wherein the data output order is set corresponding to circuit arrangement in the data line driver circuit.

11. The integrated circuit device as defined in claim 10,
wherein the data line driver circuit includes a digital-analogue converter;
wherein the digital-analogue converter has a one-pixel conversion region in which data of each of the pixels is converted; and
wherein well structures of two one-pixel conversion regions adjacent in the wordline direction are disposed in a mirror image across a boundary between the two one-pixel conversion regions.

12. The integrated circuit device as defined in claim 1,
wherein each of the memory cells is formed in a shape of a rectangle having a long side along the first direction in which the bitlines extend and a short side along the second direction in which the wordlines extend.

13. The integrated circuit device as defined in claim 1,
wherein the data memory is divided into a plurality of RAM blocks; and
wherein each of the RAM blocks includes the memory output circuit.

14. The integrated circuit device as defined in claim 1,
wherein the data memory is one block obtained by dividing a display memory which stores data of at least one frame displayed in a display panel having a plurality of pixels connected with a plurality of scan lines and a plurality of data lines.

15. The integrated circuit device as defined in claim 14,
wherein N different wordlines (N is an integer larger than 1) among the wordlines are sequentially selected in one horizontal scan period of the display panel.

16. An electronic instrument comprising the integrated circuit device as defined in claim 1.
